(19) United States
(12) Patent Application Publication
(10) Pub. No.: US 2025/0337115 A1
(43) Pub. Date: Oct. 30, 2025

(54) SEPARATOR, ELECTROCHEMICAL APPARATUS, AND ELECTRONIC APPARATUS

(71) Applicant: Ningde Amperex Technology Limited, Ningde (CN)

(72) Inventors: Changchuan XIONG, Ningde (CN); Zengbin WEI, Ningde (CN)

(73) Assignee: Ningde Amperex Technology Limited, Ningde (CN)

(21) Appl. No.: 19/194,183

(22) Filed: Apr. 30, 2025

(30) Foreign Application Priority Data
Apr. 30, 2024 (CN) 202410543577.0

(51) Int. Cl. H01M 50/451; H01M 10/0525; H01M 50/443; H01M 50/46; H01M 50/463; H01M 50/497

(52) U.S. Cl. CPC H01M 50/451; H01M 10/0525; H01M 50/443; H01M 50/461; H01M 50/463; H01M 50/497

(57) ABSTRACT

A separator includes a substrate, an inorganic coating layer, and an adhesive layer, where the inorganic coating layer and the adhesive layer are disposed on a first surface of the substrate. The inorganic coating layer is disposed between the substrate and the adhesive layer. The adhesive layer is disposed on a second surface of the substrate. The inorganic coating layer includes filler particles. The adhesive layer includes polymer particles. The separator includes a first surface provided with the inorganic coating layer and the adhesive layer. In a region with an area of 100 μm² on the first surface, a quantity of the polymer particles is A, where 10≤A≤100. An average particle size of the filler particles is Dᵥ50₋₁ μm, and an average particle size of the polymer particles is Dᵥ50₋₂ μM, WHERE Dᵥ50₋₁ AND Dᵥ50₋₂ SATISFY 0.2≤Dᵥ50₋₁/Dᵥ50₋₂≤2.5 AND 0.2≤Dᵥ50₋₁≤1.

### CROSS REFERENCE TO RELATED APPLICATIONS

This application claims priority to the Chinese Patent Application Ser. No. 202410543577.0, filed on Apr. 30, 2024, the content of which is incorporated herein by reference in its entirety.

### TECHNICAL FIELD

This application relates to the field of electrochemical technologies, and in particular, to a separator, an electrochemical apparatus, and an electronic apparatus.

### BACKGROUND

With the popularization of electronic products such as notebook computers, mobile phones, handheld game consoles, and tablet computers, people impose increasingly strict requirements on electrochemical apparatuses (for example, lithium-ion batteries). Lithium-ion batteries have been widely used in the fields such as electric energy storage, portable electronic devices, and electric vehicles by virtue of their characteristics such as high energy density, high working voltage, low self-discharge rate, small size, and light weight. However, the existing lithium-ion batteries are prone to technical problems such as excessively quick cycling attenuation or poor low-temperature performance. Therefore, how the cycling performance and low-temperature performance of lithium-ion batteries are balanced has become an urgent technical issue that needs to be addressed by persons skilled in the art.

### SUMMARY

A purpose of this application is to provide a separator, an electrochemical apparatus, and an electronic apparatus, so as to enhance the adhesive force of the separator as well as the transport and distribution uniformity of an electrolyte in the separator, such that the electrochemical apparatus has improved room-temperature cycling performance and low-temperature cycling performance while having good safety performance.

It should be noted that in the invention content of this application, an example in which a lithium-ion battery is used as an electrochemical apparatus is used to illustrate this application. However, the electrochemical apparatus of this application is not limited to the lithium-ion battery. Specific technical solutions are as follows.

According to a first aspect, this application provides a separator. The separator includes a substrate, an inorganic coating, and an adhesive layer, where the inorganic coating and the adhesive layer are disposed on one surface of the substrate.

The inorganic coating is disposed between the substrate and the adhesive layer. The adhesive layer is disposed on the other surface of the substrate. The inorganic coating includes filler particles. The adhesive layer includes polymer particles. The separator includes a first surface provided with the inorganic coating and the adhesive layer. In a region with an area of 100 μm² on the first surface, a quantity of the polymer particles is A, where 10≤A≤100. An average particle size of the filler particles is Dᵥ50₋₁ μm, and an average particle size of the polymer particles is Dᵥ50₋₂ μm, where Dᵥ50₋₁ and Dᵥ50₋2 satisfy 0.2≤Dᵥ50₋₁/Dᵥ50₋₂≤2.5 and 0.2Dᵥ50₋₁≤1. In this application, the quantity A of the polymer particles in the first surface of the separator, the average particle size Dᵥ50₋₁ of the filler particles in the inorganic coating, and a ratio Dᵥ50₋₁/Dᵥ50₋₂ of the average particle size of the filler particles in the inorganic coating and the average particle size of the polymer particles in the adhesive layer are adjusted to be within the ranges provided in this application, so that when the separator is used in an electrochemical apparatus, the first surface of the separator has good adhesion uniformity to a surface of a positive electrode plate or a negative electrode plate, lithium ions and an electrolyte have good transport and distribution uniformity in the separator, and the electrolyte is uniformly transported to and distributed in various regions of the separator, ensuring good wettability of the separator. This facilitates fast transport of the lithium ions, thereby helping to improve the room-temperature cycling performance and low-temperature cycling performance of the electrochemical apparatus. In addition, the electrochemical apparatus has good safety performance.

In some embodiments of this application, 0.4≤Dᵥ50₋₂≤1. Adjusting the average particle size of the polymer particles to be within the above range helps to improve the room-temperature cycling performance and low-temperature cycling performance of the electrochemical apparatus while the electrochemical apparatus has good safety performance.

In some embodiments of this application, 10≤A≤60. Adjusting the quantity of the polymer particles in the region with an area of 100 μm² on the first surface to be within the above range helps to further improve the room-temperature cycling performance and low-temperature cycling performance of the electrochemical apparatus while the electrochemical apparatus has good safety performance.

In some embodiments of this application, 0.7≤Dᵥ50₋₁/Dᵥ50₋₂≤1.6. Adjusting a value of Dᵥ50₋₁/Dᵥ50₋₂ to be within the above range helps to further improve the room-temperature cycling performance and low-temperature cycling performance of the electrochemical apparatus while the electrochemical apparatus has good safety performance.

In some embodiments of this application, 0.5≤Dᵥ50₋₁≤0.8. Adjusting the average particle size Dᵥ50₋₁ of the filler particles to be within the above range helps to improve the room-temperature cycling performance and low-temperature cycling performance of the electrochemical apparatus while the electrochemical apparatus has good safety performance.

In some embodiments of this application, 0.5≤Dᵥ50₋₂≤0.8. Adjusting the average particle size Dᵥ50₋₂ of the polymer particles to be within the above range helps to further improve the room-temperature cycling performance and low-temperature cycling performance of the electrochemical apparatus.

In some embodiments of this application, a thickness of the inorganic coating is 0.2 μm to 2 μm. Adjusting the thickness of the inorganic coating to be within the above range allows the electrochemical apparatus to have high energy density while having good room-temperature cycling performance and low-temperature cycling performance.

In some embodiments of this application, a thickness of the inorganic coating is 0.5 μm to 1.5 μm. Adjusting the thickness of the inorganic coating to be within the above range helps to further improve the room-temperature cycling performance, low-temperature cycling performance, and energy density of the electrochemical apparatus.

In some embodiments of this application, a coverage rate of the adhesive layer on the inorganic coating is 20% to 90%. Adjusting the coverage rate of the adhesive layer on the inorganic coating to be within the above range facilitates an adhesion effect of the adhesive layer and helps to improve the room-temperature cycling performance and low-temperature cycling performance of the electrochemical apparatus while the electrochemical apparatus has good safety performance.

In some embodiments of this application, the coverage rate of the adhesive layer on the inorganic coating is 20% to 60%. Adjusting the coverage rate of the adhesive layer on the inorganic coating to be within the above range helps to further enhance the adhesion effect of the adhesive layer and further improve the room-temperature cycling performance and low-temperature cycling performance of the electrochemical apparatus while the electrochemical apparatus has good safety performance.

In some embodiments of this application, the inorganic coating further includes an inorganic coating binder. The filler particles include at least one of boehmite, aluminum oxide, zirconium oxide, titanium dioxide, magnesium oxide, mullite, silicon carbide, or silicon nitride. The inorganic coating binder includes at least one of polyvinyl alcohol, polyacrylic acid, hydroxypropyl cellulose, styrene-butadiene rubber, or polymethyl methacrylate. Based on a mass of the inorganic coating, a mass percentage of the filler particles is 95% to 99%, and a mass percentage of the inorganic coating binder is 1% to 5%. With the above arrangement, the inorganic coating has good use performance. Using the separator in the electrochemical apparatus helps to allow the electrochemical apparatus to have good room-temperature cycling performance and low-temperature cycling performance.

In some embodiments of this application, the adhesive layer further includes an auxiliary binder, the polymer particles include at least one of polyvinylidene fluoride, polymethyl methacrylate, polymethyl acrylate, or polyethyl acrylate, and the auxiliary binder includes at least one of polyvinyl alcohol, polyacrylic acid, hydroxypropyl cellulose, or styrene-butadiene rubber. Based on a mass of the adhesive layer, a mass percentage of the polymer particles is 97% to 99.5%, and a mass percentage of the auxiliary binder is 0.5% to 3%. With the above arrangement, the adhesive layer has desired adhesive force. Using the separator in the electrochemical apparatus helps to allow the electrochemical apparatus to have good room-temperature cycling performance and low-temperature cycling performance.

In some embodiments of this application, the other surface of the substrate is further provided with the inorganic coating, and the inorganic coating is disposed between the substrate and the adhesive layer.

In some embodiments of this application, an impedance of the adhesive layer is 0.05Ω to 0.5Ω. The impedance of the adhesive layer being within the above range helps to improve the room-temperature cycling performance and low-temperature cycling performance of the electrochemical apparatus.

In some embodiments of this application, the impedance of the adhesive layer is 0.05Ω to 0.2Ω. The impedance of the adhesive layer being within the above range helps to further improve the room-temperature cycling performance and low-temperature cycling performance of the electrochemical apparatus.

In some embodiments of this application, an adhesive force F₁ of the first surface to a positive electrode plate is 10 N/m to 40 N/m, and an adhesive force F₂ of the first surface to a negative electrode plate is 10 N/m to 30 N/m. This indicates that the first surface of the separator has desired adhesive force to the positive electrode plate and the negative electrode plate.

In some embodiments of this application, the adhesive force F₁ of the first surface to the positive electrode plate is 10 N/m to 30 N/m, and an adhesive force F₂ of the first surface to the negative electrode plate is 10 N/m to 20 N/m. This indicates that the first surface of the separator has desired adhesive force to the positive electrode plate and the negative electrode plate.

According to a second aspect, this application provides an electrochemical apparatus, where the electrochemical apparatus includes the separator according to any one of the foregoing embodiments. Therefore, the electrochemical apparatus has good room-temperature cycling performance and low-temperature cycling performance.

According to a third aspect, this application provides an electronic apparatus, where the electronic apparatus includes the electrochemical apparatus according to any one of the foregoing embodiments. Therefore, the electronic apparatus has good use performance.

This application has the following beneficial effects.

This application provides a separator, an electrochemical apparatus, and an electronic apparatus. In this application, the quantity A of the polymer particles in the first surface of the separator is adjusted to be 10 to 100, the average particle size Dᵥ50₋₁ of the filler particles in the inorganic coating, and a ratio Dᵥ50₋₁/Dᵥ50₋₂ of the average particle size of the filler particles in the inorganic coating and the average particle size of the polymer particles in the adhesive layer are adjusted to satisfy 0.2≤Dᵥ50₋₁/Dᵥ50₋₂≤2.5 and 0.2≤Dᵥ50₋₁≤1, so that when the separator is used in the electrochemical apparatus, the first surface of the separator has good adhesion uniformity to the surface of the positive electrode plate or the negative electrode plate, the lithium ions and the electrolyte have good transport and distribution uniformity in the separator, and the electrolyte is uniformly transported to and distributed in various regions of the separator and thus has good infiltration performance to the separator. This facilitates fast transport of the lithium ions, thereby helping to improve the room-temperature cycling performance and low-temperature cycling performance of the electrochemical apparatus while the electrochemical apparatus has good safety performance.

Certainly, when any product or method of this application is implemented, all advantages described above are not necessarily demonstrated simultaneously.

### BRIEF DESCRIPTION OF DRAWINGS

To describe the technical solutions in some embodiments of this application more clearly, the following briefly describes the accompanying drawings required for describing some embodiments. Apparently, the accompanying drawings in the following descriptions show merely some embodiments of this application, and persons of ordinary skill in the art may still derive other embodiments from these accompanying drawings.

FIG. 1 is a schematic cross-sectional structural diagram of a separator in its thickness direction and width direction according to some embodiments of this application;

FIG. 2 is a schematic cross-sectional structural diagram of a separator in its thickness direction and width direction according to some other embodiment of this application; and

FIG. 3 is a test diagram of a first surface of a separator according to some embodiments of this application.

### REFERENCE SIGNS

10. separator; 11. substrate; 12. inorganic coating; 13. adhesive layer; 101. first surface; 102. second surface; 113. third surface; 114. fourth surface; 131. polymer particle; and 30. test region.

### DETAILED DESCRIPTION

The following clearly describes the technical solutions in some embodiments of this application with reference to the accompanying drawings in some embodiments of this application. Apparently, the described embodiments are only some rather than all of these embodiments of this application. All other embodiments obtained by persons skilled in the art based on this application shall fall within the protection scope of this application.

It should be noted that, in the specific embodiments of this application, an example in which a lithium-ion battery is used as an electrochemical apparatus is used to illustrate this application. However, the electrochemical apparatus of this application is not limited to the lithium-ion battery.

According to a first aspect, this application provides a separator. The separator includes a substrate, an inorganic coating, and an adhesive layer, where the inorganic coating and the adhesive layer are disposed on one surface of the substrate.

The inorganic coating is disposed between the substrate and the adhesive layer. The adhesive layer is disposed on the other surface of the substrate. The inorganic coating includes filler particles. The adhesive layer includes polymer particles. The separator includes a first surface provided with the inorganic coating and the adhesive layer. In a region with an area of 100 μm² on the first surface, a quantity of the polymer particles is A, where 10≤A≤100. An average particle size of the filler particles is Dᵥ50.1 μm, and an average particle size of the polymer particles is Dᵥ50₋₂ μm, where Dᵥ50-1 and Dᵥ50-2 satisfy 0.2≤Dᵥ50-1/Dᵥ50-2≤2.5 and 0.2Dᵥ50-1≤1.

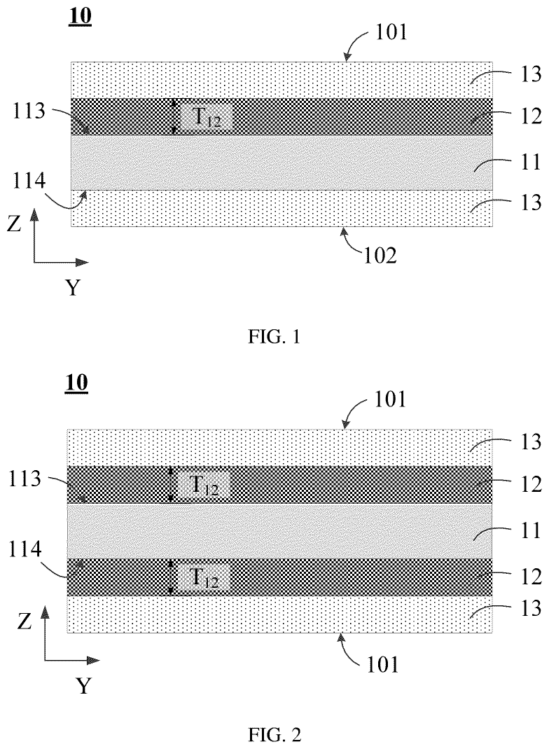

For ease of understanding, in this application, a width direction of the separator is defined as Y, and a thickness direction of the separator is defined as Z. It should be understood that the above definitions of direction are for ease of describing this application, and the directions defined in this application can be understood based on the accompanying drawings and relative positions of actual product elements. Moreover, width directions and thickness directions of the substrate, the inorganic coating, and the adhesive layer are the same as those of the separator. As shown in FIG. 1, a separator 10 includes a substrate 11, an inorganic coating 12, and an adhesive layer 13. The substrate 11 includes a third surface 113 and a fourth surface 114 disposed opposite each other in the thickness direction Z. The inorganic coating 12 and the adhesive layer 13 are sequentially disposed on the third surface 113 of the substrate 11, and adhesive layer 13 is disposed on the fourth surface 114 of the substrate 11. A side surface of the separator 10 where the inorganic coating 12 and the adhesive layer 13 are disposed is referred to as the first surface 101, while a side surface of the separator 10 where only the adhesive layer 13 is disposed and no inorganic coating 12 is disposed is referred to as the second surface 102.

For example, A may be 10, 21, 30, 40, 46, 50, 57, 62, 70, 80, 86, 91, 100, or any value within a range defined by any two of these values. When A is less than 10, the quantity of the polymer particles on the surface of the separator is too small, the coverage rate of the adhesive layer on the inorganic coating is too low, or the average particle size of the polymer particles is too large, resulting in excessively low adhesive force of the adhesive layer. This leads to uneven adhesion between the first surface of the separator and the surface of the positive electrode plate or negative electrode plate. Consequently, an adhesion effect between the separator and the positive electrode plate or negative electrode plate is too poor, causing uneven transport and distribution of the lithium ions and electrolyte in the separator, thereby reducing the room-temperature cycling performance and low-temperature cycling performance of the electrochemical apparatus. When A is greater than 100, the quantity of the polymer particles on the surface of the separator is too large, indicating that the average particle size of the polymer particles is too small; in a drying process of the adhesive layer, the polymer particles aggregate to hinder the transport of the lithium ions on the first surface of the separator, and this also leads to uneven transport and distribution of the lithium ions and electrolyte on the first surface of the separator. Furthermore, the polymer particles with a small particle size are prone to aggregation, resulting in non-uniform distribution of the polymer particles, thereby causing uneven adhesion between the first surface of the separator and the surface of the positive electrode plate or negative electrode plate.

For example, Dᵥ50₋₁/Dᵥ50₋₂ may be 0.2, 0.5, 0.7, 1.1, 1.5, 1.7, 2.0, 2.2, 2.5, or any value within a range defined by any two of these values. When a value of Dᵥ50₋₁/Dᵥ50₋₂ is less than 0.2, the average particle size of the filler particles is too small compared to the average particle size of the polymer particles, resulting in excessively small adhesive force between the adhesive layer and the inorganic coating. Consequently, during the use of the separator, the probability of the adhesive layer peeling off from the inorganic coating is high, which affects normal use of the separator and in turn affects normal operation of the electrochemical apparatus. When the value of Dᵥ50₋₁/Dᵥ50₋₂ is greater than 2.5, the average particle size of the filler particles is too large compared to the average particle size of the polymer particles, so the polymer particles are likely to fall into gaps formed between the filler particles, hindering the performance of the polymer particles and affecting the adhesive force of the separator, thereby causing a poor adhesion effect between the separator and the positive electrode plate or negative electrode plate.

For example, Dᵥ50₋₁ may be 0.2, 0.3, 0.4, 0.5, 0.6, 0.7, 0.8, 0.9, 1, or any value within a range defined by any two of these values. When Dᵥ50₋₁ is less than 0.2, the average particle size of the filler particles is too small, thus the filler particles are likely to agglomerate during preparation of the inorganic coating, causing non-uniform distribution of the filler particles in the inorganic coating. In addition, excessively small surface roughness of the formed inorganic coating results in an excessively small adhesive force between the inorganic coating and the adhesive layer disposed on the surface of the inorganic coating. Therefore, during use of the separator, the adhesive layer is highly likely to fall off, affecting the safety performance of the electrochemical apparatus. When Dᵥ50₋₁ is greater than 1, the average particle size of the filler particles is too large, the polymer particles are likely to fall into gaps formed between the filler particles, hindering the performance of the polymer particles and affecting the adhesive force of the separator, thereby causing a poor adhesion effect between the separator and the positive electrode plate or negative electrode plate, and affecting the safety performance of the electrochemical apparatus.

Overall, the quantity A of the polymer particles in the first surface of the separator, the average particle size Dᵥ50₋₁ of the filler particles in the inorganic coating, and a ratio Dᵥ50₋₁/Dᵥ50₋₂ of the average particle size of the filler particles in the inorganic coating and the average particle size of the polymer particles in the adhesive layer are adjusted to be within the ranges provided in this application, so that when the separator is used in the electrochemical apparatus, the first surface of the separator has good adhesion uniformity to the surface of the positive electrode plate or the negative electrode plate, and the lithium ions and the electrolyte have good transport and distribution uniformity in the separator. This facilitates fast transport of the lithium ions, thereby helping to improve the room-temperature cycling performance and low-temperature cycling performance of the electrochemical apparatus while the electrochemical apparatus has good safety performance.

In this application, there is no specific limitation on a method for adjusting the quantity of the polymer particles in a region with an area of 100 μm² on the first surface, as long as the purpose of this application can be achieved. For example, this can be implemented by adjusting the coverage rate of the adhesive layer on the inorganic coating.

In this application, “average particle size” refers to a particle size of the particles that reach 50% of a cumulative volume from a small particle size side in volume-based particle size distribution. The above-mentioned “particles” may refer to either the filler particles in this application or the polymer particles in this application.

A method for adjusting the average particle size of the filler particles is not particularly limited in this application, as long as the purpose of this application can be achieved. For example, filler particles with a required average particle size can be obtained through grinding, sieving, or the like.

A method for adjusting the average particle size of the polymer particles is not particularly limited in this application, as long as the purpose of this application can be achieved. For example, commercially available polymer particles with an average particle size within the range provided in this application may be selected, and the average particle size of the polymer particles is determined with reference to the “Test for average particle size of polymer particles” described in this application, thereby realizing the selection of polymer particles with the required average particle size. For example, polymer particles with the required average particle size may be obtained through grinding, sieving, or the like.

In some embodiments of this application, 10≤A≤60. For example, A may be 10, 20, 30, 40, 46, 50, 57, 60, or any value within a range defined by any two of these values. Adjusting the quantity of the polymer particles in the region with an area of 100 μm² on the first surface to be within the above range helps to further improve the adhesion uniformity between the first surface of the separator and the surface of the positive electrode plate and/or negative electrode plate and further improve the transport and distribution uniformity of the lithium ions and electrolyte in the separator, thereby further improving the room-temperature cycling performance and low-temperature cycling performance of the electrochemical apparatus while the electrochemical apparatus has good safety performance.

In some embodiments of this application, 0.7≤Dᵥ50₋₁/Dᵥ50₋₂≤1.6. For example, Dᵥ50₋₁/Dᵥ50₋₂ may be 0.7, 1.1, 1.2, 1.3, 1.4, 1.5, 1.6, or any value within a range defined by any two of these values. Adjusting the value of Dᵥ50₋₁/Dᵥ50₋₂ to be within the above range allows for a higher matching degree between the average particle sizes of the filler particles and the polymer particles, so that a desired adhesive force is formed between the inorganic coating and the adhesive layer, helping to improve the adhesion uniformity between the first surface of the separator and the surface of the positive electrode plate or negative electrode plate and further improve the transport and distribution uniformity of the lithium ions and electrolyte in the separator, thereby further improving the room-temperature cycling performance and low-temperature cycling performance of the electrochemical apparatus while the electrochemical apparatus has good safety performance.

In some embodiments of this application, 0.5≤Dᵥ50₋₁≤0.8. For example, Dᵥ50₋₁ may be 0.5, 0.6, 0.7, 0.8, or any value within a range defined by any two of these values. Adjusting the average particle size Dᵥ50₋₁ of the filler particles to be within the above range facilitates uniform distribution of the filler particles in the inorganic coating and thus helps to enhance the adhesive force between the inorganic coating and the adhesive layer, thereby allowing the separator to have good use performance. Using the separator in the electrochemical apparatus helps to allow the electrochemical apparatus to have improved room-temperature cycling performance and low-temperature cycling performance while having good safety performance.

In some embodiments of this application, 0.4≤Dᵥ50₋₂≤1. For example, Dᵥ50₋₂ may be 0.4, 0.5, 0.6, 0.7, 0.8, 0.9, 1, or any value within a range defined by any two of these values. Adjusting the average particle size of the polymer particles to be within the above range facilitates uniform distribution of the polymer particles in the adhesive layer, so that the polymer particles have good adhesion uniformity with the inorganic coating, helping to improve the adhesion uniformity between the first surface of the separator and the surface of the positive electrode plate or negative electrode plate and facilitating the transport and distribution uniformity of the lithium ions and electrolyte in the separator, thereby helping to improve the room-temperature cycling performance and low-temperature cycling performance of the electrochemical apparatus.

In some embodiments of this application, 0.5≤Dᵥ50₋₂≤0.8. For example, Dᵥ50₋₂ may be 0.5, 0.6, 0.7, 0.8, or any value within a range defined by any two of these values. Adjusting the average particle size Dᵥ50₋₂ of the polymer particles to be within the above range helps to further improve the room-temperature cycling performance and low-temperature cycling performance of the electrochemical apparatus.

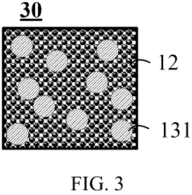

In some embodiments of this application, as shown in FIG. 1 and FIG. 2, a thickness T₁₂ of the inorganic coating 12 is 0.2 μm to 2 μm. For example, the thickness of the inorganic coating is 0.2 μm, 0.4 μm, 0.5 μm, 0.8 μm, 1μ, 1.2 μm, 1.4 μm, 1.8 μm, 2 μm, or any value within a range defined by any two of these values. Adjusting the thickness of the inorganic coating to be within the above range allows the separator to have a small thickness, thereby reducing the risk of energy density loss caused by a volume increase of the electrochemical apparatus due to a thickness increase of the separator. Thus, the electrochemical apparatus has high energy density while having good room-temperature cycling performance and low-temperature cycling performance.

In some embodiments of this application, as shown in FIG. 1 and FIG. 2, the thickness T₁₂ of the inorganic coating 12 is 0.5 μm to 1.5 μm. For example, the thickness of the inorganic coating is 0.5 μm, 0.8 μm, 1 μm, 1.2 μm, 1.4 μm, 1.5 μm, or any value within a range defined by any two of these values. Adjusting the thickness of the inorganic coating to be within the above range helps to further improve the room-temperature cycling performance, low-temperature cycling performance, and energy density of the electrochemical apparatus.

In some embodiments of this application, the coverage rate of the adhesive layer on the inorganic coating is 20% to 90%. For example, the coverage rate of the adhesive layer on the inorganic coating is 20%, 30%, 46%, 50%, 57%, 70%, 80%, 90%, or any value within a range defined by any two of these values. Adjusting the coverage rate of the adhesive layer on the inorganic coating to be within the above range facilitates an adhesion effect of the adhesive layer and allows for good adhesion uniformity between the first surface of the separator and the surface of the positive electrode plate and/or negative electrode plate, improving the transport and distribution uniformity of the lithium ions and electrolyte in the separator, thereby improving the room-temperature cycling performance and low-temperature cycling performance of the electrochemical apparatus while the electrochemical apparatus has good safety performance.

In some embodiments of this application, the coverage rate of the adhesive layer on the inorganic coating is 20% to 60%. For example, the coverage rate of the adhesive layer on the inorganic coating is 20%, 25%, 26%, 30%, 34%, 37%, 40%, 50%, 60% or any value within a range defined by any two of these values. Adjusting the coverage rate of the adhesive layer on the inorganic coating to be within the above range helps to further enhance the adhesion effect of the adhesive layer and further improves the adhesion uniformity between the first surface of the separator and the surface of the positive electrode plate and/or negative electrode plate, further improving the transport and distribution uniformity of the lithium ions and electrolyte in the separator, thereby further improving the room-temperature cycling performance and low-temperature cycling performance of the electrochemical apparatus.

A method for adjusting the coverage rate of the adhesive layer on the inorganic coating is not particularly limited in this application, as long as the purpose of this application can be achieved. For example, this can be implemented based on adjustment of process parameters such as a spray-coating time during spray coating of the adhesive layer. For example, this can be implemented by adjusting the quantity of the polymer particles and/or the particle size of the polymer particles.

In some embodiments of this application, the inorganic coating further includes an inorganic coating binder. The filler particles include at least one of boehmite, aluminum oxide, zirconium oxide, titanium dioxide, magnesium oxide, mullite, silicon carbide, or silicon nitride. The inorganic coating binder includes at least one of polyvinyl alcohol (PVA), polyacrylic acid (PAA), hydroxypropyl cellulose, styrene-butadiene rubber (SBR), or polymethyl methacrylate. Based on a mass of the inorganic coating, a mass percentage of the filler particles is 95% to 99%, and a mass percentage of the inorganic coating binder is 1% to 5%. For example, the mass percentage of the filler particles is 95%, 96%, 97%, 98%, 99%, or any value within a range defined any two of these values. For example, the mass percentage of the inorganic coating binder is 1%, 2%, 3%, 4%, 5%, or any value within a range defined by any two of these values. The above types of filler particles and inorganic coating binder are used, and the mass percentages of the filler particles and the inorganic coating binder in the inorganic coating are adjusted to be within the above ranges, to prepare an inorganic coating with good use performance, so that the electrolyte has good infiltration performance to the separator, and the separator has low impedance and high porosity. Therefore, using the separator in the electrochemical apparatus allows the electrochemical apparatus to have good room-temperature cycling performance and low-temperature cycling performance.

In some embodiments of this application, the adhesive layer further includes an auxiliary binder, the polymer particles include at least one of polyvinylidene fluoride, polymethyl methacrylate, polymethyl acrylate, or polyethyl acrylate, and the auxiliary binder includes at least one of polyvinyl alcohol, polyacrylic acid, hydroxypropyl cellulose, or styrene-butadiene rubber. Based on a mass of the adhesive layer, a mass percentage of the polymer particles is 97% to 99.5%, and a mass percentage of the auxiliary binder is 0.5% to 3%. For example, the mass percentage of the polymer particles is 97%, 97.6%, 98%, 99%, 99.5%, or any value within a range defined by any two of these values. For example, the mass percentage of the inorganic coating binder is 0.5%, 1%, 2%, 2.5%, 3%, or any value within a range defined by any two of these values. The above types of polymer particles and auxiliary binder are used, and the mass percentages of the polymer particles and the auxiliary binder in the adhesive layer are adjusted to be within the above ranges, to prepare an adhesive layer with a desired adhesive force, facilitating the use of the separator in the electrochemical apparatus, allowing for a large adhesive force between the separator and the positive electrode plate and negative electrode plate, and allowing the electrochemical apparatus to have good room-temperature cycling performance and low-temperature cycling and low-temperature cycling performance.

In some embodiments of this application, the other surface of the substrate is provided with the inorganic coating and the adhesive layer, and the inorganic coating is disposed between the substrate and the adhesive layer. As shown in FIG. 2, the separator 10 includes a substrate 11, an inorganic coating 12, and an adhesive layer 13. The substrate 11 includes a third surface 113 and a fourth surface 114 disposed opposite each other in a thickness direction Z. The inorganic coating 12 and the adhesive layer 13 are sequentially disposed on the third surface 113 of the substrate 11, and the inorganic coating 12 and the adhesive layer 13 are sequentially disposed on the fourth surface 114 of the substrate 11. The inorganic coating 12 is disposed between the substrate 11 and the adhesive layer 13. Two side surfaces of the separator 12, which are disposed opposite each other in the thickness direction Z, are both referred to as the first surface 101. Further disposing the inorganic coating and the adhesive layer on the other surface of the substrate can further enhance the hardness and adhesive force of the separator. Both surfaces of the separator have desired adhesive force and can have good adhesion uniformity with the surfaces of the positive electrode plate and negative electrode plate. The lithium ions and electrolyte have good transport and distribution uniformity in the separator, facilitating fast transport of the lithium ions and increasing an electrolyte retention rate of the separator, thereby further improving the room-temperature cycling performance and low-temperature cycling performance of the electrochemical apparatus.

In some embodiments of this application, the impedance of the adhesive layer is 0.05Ω to 0.5Ω. For example, the impedance of the adhesive layer is 0.05 Ω, 0.1 Ω, 0.15 Ω, 0.2 Ω, 0.25 Ω, 0.3 Ω, 0.4 Ω, 0.5Ω, or any value within a range defined by any two of these values. The impedance of the adhesive layer being within the above range helps to increase a transport speed of the lithium ions, thereby improving the room-temperature cycling performance and low-temperature cycling performance of the electrochemical apparatus.

In some embodiments of this application, the impedance of the adhesive layer is 0.05Ω to 0.2Ω. For example, the impedance of the adhesive layer is 0.05Ω, 0.1Ω, 0.11Ω, 0.14Ω, 0.15Ω, 0.17Ω, 0.18Ω, 0.2Ω, or any value within a range defined by any two of these values. The impedance of the adhesive layer being within the above range helps to further improve the room-temperature cycling performance and low-temperature cycling performance of the electrochemical apparatus.

In some embodiments of this application, an adhesive force F₁ of the first surface to the positive electrode plate is 10 N/m to 40 N/m, and an adhesive force F₂ of the first surface to the negative electrode plate is 10 N/m to 30 N/m. It should be noted that the “adhesive force of the first surface to the positive electrode plate” may alternatively be understood as an adhesive force between the first surface of a side of the separator where the inorganic coating and adhesive layer are disposed and the positive electrode plate, and the “adhesive force of the first surface to the negative electrode plate” may alternatively be understood as an adhesive force between the first surface of a side of the separator where the inorganic coating and adhesive layer are disposed and the negative electrode plate. For example, the adhesive force of the first surface to the positive electrode plate is 10 N/m, 13 N/m, 17 N/m, 20 N/m, 25 N/m, 30 N/m, 33 N/m, 40 N/m, or any value within a range defined by any two of these values. For example, the adhesive force of the first surface to the negative electrode plate is 10 N/m, 13 N/m, 17 N/m, 20 N/m, 25 N/m, 28 N/m, 30 N/m, or any value within a range defined by any two of these values. When the separator is used in the electrochemical apparatus, the first surface of the separator has a desired adhesive force with the positive electrode plate and negative electrode plate, helping to allow the electrochemical apparatus to have good room-temperature cycling performance and low-temperature cycling performance while having good safety performance.

In some embodiments of this application, the adhesive force F₁ of the first surface to the positive electrode plate is 10 N/m to 30 N/m, and the adhesive force F₂ of the first surface to the negative electrode plate is 10 N/m to 20 N/m. For example, the adhesive force of the first surface to the positive electrode plate is 10 N/m, 13 N/m, 17 N/m, 20 N/m, 25 N/m, 30 N/m, or any value within a range defined by any two of these values. For example, the adhesive force of the first surface to the negative electrode plate is 10 N/m, 13 N/m, 15 N/m, 16 N/m, 18 N/m, 20 N/m, or any value within a range defined by any two of these values. When the separator is used in the electrochemical apparatus, the first surface of the separator has a desired adhesive force with the positive electrode plate and negative electrode plate, helping to allow the electrochemical apparatus to have good room-temperature cycling performance and low-temperature cycling performance while having good safety performance.

The substrate in the separator is not particularly limited, as long as persons skilled in the art can select it based on actual needs and as long as the purpose of this application can be achieved. For example, a material of the substrate may include but is not limited to at least one of polyethylene (PE), polypropylene (PP), or polyethylene terephthalate (PET). The substrate may be a single-layer structure or a multi-layer structure. For example, the multi-layer may mean two layers, three layers, or four layers. A thickness of the substrate may be 3 μm to 20 μm. A porosity of the substrate may be 20% to 50%. A pore size of the substrate may be 30 nm to 50 nm.

A preparation method of the separator is not particularly limited in this application, as long as the purpose of this application can be achieved. For example, in some embodiments, the preparation method of the separator includes but is not limited to the following steps: (1) well mixing inorganic particles with an inorganic coating binder and adding a solvent to prepare an inorganic coating slurry with a solid content of 20 wt % to 60 wt %; and well mixing polymer particles with an auxiliary binder and adding a solvent to prepare an adhesive layer slurry with a solid content of 1 wt % to 30 wt %; (2) applying the inorganic coating slurry onto one surface of the substrate and performing drying to form an inorganic coating; and (3) spraying the adhesive layer slurry onto the surface of the inorganic coating facing away from the substrate, performing drying, and directly spraying the adhesive layer slurry onto the other surface of the substrate, and performing drying to obtain a separator. In some other embodiments, the preparation method of the separator includes but is not limited to the following steps: (1) well mixing inorganic particles with an inorganic coating binder and adding a solvent to prepare an inorganic coating slurry with a solid content of 20 wt % to 60 wt %; and well mixing polymer particles with an auxiliary binder and adding a solvent to prepare an adhesive layer slurry with a solid content of 1 wt % to 30 wt %; (2) applying the inorganic coating slurry onto both surfaces of the substrate and performing drying to form an inorganic coating; and (3) spraying the adhesive layer slurry onto both surfaces of the inorganic coating facing away from the substrate, and performing drying to obtain a separator. A type of the “solvent” is not particularly limited in this application, as long as the purpose of this application can be achieved.

According to a second aspect, this application provides an electrochemical apparatus, where the electrochemical apparatus includes the separator according to any one of the foregoing embodiments. Therefore, the electrochemical apparatus has good room-temperature cycling performance and low-temperature cycling performance.

In some embodiments of this application, the electrochemical apparatus includes a separator, a positive electrode plate, and a negative electrode plate. The separator is located between the positive electrode plate and the negative electrode plate for separating the positive electrode plate from the negative electrode plate. In some embodiments, the structure of the separator is as shown in FIG. 1. When the separator is used in the electrochemical apparatus, the first surface of the separator is adjacent to the positive electrode plate, and a second surface of the separator is adjacent to the negative electrode plate.

The positive electrode plate is not particularly limited in this application, as long as the purpose of this application can be achieved. For example, the positive electrode plate includes a positive electrode current collector and a positive electrode active material layer. The positive electrode current collector is not particularly limited in this application, as long as the purpose of this application can be achieved. For example, the positive electrode current collector may include aluminum foil, aluminum alloy foil, or the like. The positive electrode active material layer in this application includes a positive electrode active material. A type of the positive electrode active material is not particularly limited in this application, as long as that the purpose of this application can be achieved. For example, the positive electrode active material may include at least one of lithium nickel cobalt manganate, lithium nickel cobalt aluminate, lithium iron phosphate, lithium-rich manganese-based materials, lithium cobaltate, lithium manganate, lithium iron manganese phosphate, or lithium titanate. In this application, the positive electrode active material may further include a non-metal element, for example, the non-metal element includes at least one of fluorine, phosphorus, boron, chlorine, silicon, or sulfur. These elements can further improve the stability of the positive electrode active material. In this application, thicknesses of the positive electrode current collector and the positive electrode active material layer are not particularly limited, as long as the purpose of this application can be achieved. For example, the thickness of the positive electrode current collector is 5 μm to 20 μm, preferably 6 μm to 18 μm. A thickness of a single-sided positive electrode active material layer is 30 μm to 120 μm. In this application, the positive electrode active material layer may be disposed on one surface of the positive electrode current collector in its thickness direction, or may be disposed on two surfaces of the positive electrode current collector in its thickness direction. Optionally, the positive electrode active material layer may further include a positive electrode conductive agent and a positive electrode binder. Types of the positive electrode conductive agent and the positive electrode binder in the positive electrode active material layer are not particularly limited in this application, as long as the purpose of this application can be achieved. A mass ratio of the positive electrode active material, the positive electrode conductive agent, and the positive electrode binder in the positive electrode active material layer is not particularly limited in this application, and persons skilled in the art can choose according to actual needs, as long as the purpose of this application can be achieved. For example, the mass ratio of the positive electrode active material, the positive electrode conductive agent, and the positive electrode binder in the positive electrode active material layer is (97.5-97.9):(0.8-1.7):(1.0-2.0).

The negative electrode plate is not particularly limited in this application, as long as the purpose of this application can be achieved. For example, the negative electrode plate includes a negative electrode current collector and a negative electrode active material layer. The negative electrode current collector is not particularly limited in this application, as long as the purpose of this application can be achieved. For example, the negative electrode current collector may include copper foil, copper alloy foil, nickel foil, stainless steel foil, titanium foil, nickel foam, copper foam, or the like. The negative electrode active material layer in this application includes a negative electrode active material. A type of the negative electrode active material is not particularly limited in this application, as long as that the purpose of this application can be achieved. For example, the negative electrode active material may include at least one of natural graphite, artificial graphite, mesocarbon microbeads (MCMB), hard carbon, soft carbon, silicon, a silicon-carbon composite, SiOₓ (0<x<2), a Li—Sn alloy, a Li—Sn—O alloy, Sn, SnO, SnO₂, spinel-structure lithium titanate Li₄Ti₅O₁₂, a Li—Al alloy, or lithium metal. Thicknesses of the negative electrode current collector and the negative electrode active material layer are not particularly limited in this application, as long as the purpose of this application can be achieved. For example, the thickness of the negative electrode current collector is 6 μm to 10 μm, and the thickness of the negative electrode active material layer is 30 μm to 130 μm. Optionally, the negative electrode active material layer may further include at least one of a negative electrode conductive agent, a thickener, or a negative electrode binder. Types of the negative electrode conductive agent, the thickener, and the negative electrode binder in the negative electrode active material layer are not particularly limited in this application, as long as the purpose of this application can be achieved. A mass ratio of the negative electrode active material, the negative electrode conductive agent, the thickener, and the negative electrode binder in the negative electrode active material layer is not particularly limited in this application, as long as the purpose of this application can be achieved. For example, the mass ratio of the negative electrode active material, the negative electrode conductive agent, the thickener, and the negative electrode binder in the negative electrode active material layer is (97-98):(0.5-1.5):(0-1.5):(1.0-1.9).

The electrochemical apparatus of this application further includes an electrolyte and a packaging bag, where the electrolyte, separator, positive electrode plate, and negative electrode plate are accommodated in the packaging bag. The electrolyte and packaging bag are not particularly limited in this application, and any electrolyte and packaging bag well known in the art can be used, as long as the purpose of this application can be achieved.

The electrochemical apparatus is not limited to any particular type in this application, and may include any apparatus in which electrochemical reactions take place. For example, the electrochemical apparatus may include but is not limited to a lithium metal secondary battery, a lithium-ion secondary battery (lithium-ion battery), a sodium-ion secondary battery (sodium-ion battery), a lithium polymer secondary battery, and a lithium-ion polymer secondary battery.

A preparation method of the electrochemical apparatus is not particularly limited in this application, and any preparation method well known in the art can be used, as long as the purpose of this application can be achieved. For example, a preparation method of electrochemical apparatus includes but is not limited to the following steps: stacking a separator, a positive electrode plate, a separator, and a negative electrode plate in sequence, performing operations such as winding and folding as required to obtain an electrode assembly of a wound structure, placing the electrode assembly into a packaging bag, injecting an electrolyte into the packaging bag, and sealing the packaging bag to obtain an electrochemical apparatus; or stacking a separator, a positive electrode plate, a separator, and a negative electrode plate in sequence, fixing four corners of the overall stacked structure to obtain an electrode assembly of a stacked structure, placing the electrode assembly into a packaging bag, injecting an electrolyte into the packaging bag, and sealing the packaging bag to obtain an electrochemical apparatus.

According to a third aspect, this application provides an electronic apparatus, where the electronic apparatus includes the electrochemical apparatus according to any one of the foregoing embodiments. Therefore, the electronic apparatus has good use performance.

The electronic apparatus of this application is not particularly limited, and the electronic apparatus may be any known electronic apparatus used in the prior art. For example, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a storage card, a portable recorder, a radio, a standby power source, a motor, an automobile, a motorcycle, a power-assisted bicycle, a bicycle, a lighting appliance, a toy, a game console, a clock, an electric tool, a flash lamp, a camera, a large household battery, and a lithium-ion capacitor.

### EXAMPLES

The following describes some embodiments of this application more specifically by using examples and comparative examples. Various tests and evaluations are performed according to the following methods.

### Test Method and Device:

### Test for Quantity of Polymer Particles

Step 1. A CCD camera (with a Charge-Coupled Device camera (Charge-Coupled Device, CCD for short) being used as a camera of an image sensor) is used to capture any region with an area of 100 μm² on a first surface of a to-be-tested separator, where a size of the captured region is length×width=10 μm×10 μm.

Step 2. The CCD camera is used to measure and calculate data of polymer particles in the selected region with an area of 100 μm² to obtain a quantity of the polymer particles.

For example, referring to FIG. 3, a test region 30 with a size of length×width=10 μm×10 μm is selected, polymer particles 131 are distributed on a surface of an inorganic coating 12 in the test region 30, and there are 10 polymer particles 131.

### Test for Average Particle Size of Filler Particles

A Malvern 3000 laser particle size analyzer is used to test the average particle size of the filler particles, at a refractive index of 1.76 and an absorbance of 0.1.

### Test for Average Particle Size of Polymer Particles

A Malvern 3000 laser particle size analyzer was used to test an average particle size of the polymer particles, at a refractive index of 1.59 and an absorbance of 0.1.

### Test for Impedance of Adhesive Layer

Step 1. A separator impedance testing instrument is used to measure an overall impedance of (an inorganic coating separator).

Step 2. The separator impedance testing instrument is used to measure an overall impedance of (an adhesive layer+an inorganic coating separator).

Step 3. Adhesive layer impedance-overall impedance of (adhesive layer+inorganic coating separator)−overall impedance of (inorganic coating separator).

The “inorganic coating separator” refers to a semi-finished separator in which a surface of a substrate is provided with an inorganic coating but no adhesive layer in <preparation of separator>, and the “adhesive layer+inorganic coating separator” refers to a finished separator obtained in <preparation of separator>.

### Test for Adhesive Force F₁ of First Surface of Separator to Positive Electrode Plate

A lithium-ion battery is discharged to 3 V at a constant current of 0.5 C; a packaging bag is removed; an electrode assembly is taken out; the lithium-ion battery is opened from a negative electrode side; an interface between the positive electrode plate and the separator (the positive electrode plate is adjacent to the first surface of the separator) is retained; and then the following steps are performed.

Step 1. A stamping slicer is used to punch the separator and the positive electrode plate into a test sample strip with a size of length×width=20 cm×3 cm.

Step 2. The separator and the positive electrode plate are laminated through hot pressing, where the hot pressing is performed at a temperature of 80° C. under a pressure of 1 MPa for 60 s.

Step 3. A multi-grating photovoltaic solder strip peeling force tester is used to perform a 180° peel test on the separator and the positive electrode plate after the hot-pressing lamination, and the tested peeling force is the adhesive force F₁ of the first surface of the separator to the positive electrode plate.

### Test for Adhesive Force of Separator to Negative Electrode Plate

The lithium-ion battery was discharged to 3 V at a constant current of 0.5 C; the packaging bag is removed; an electrode assembly was taken out; the lithium-ion battery is opened from the positive electrode side; and interface between the negative electrode plate and the separator is retained; and then the following steps are performed.

Step 1. A stamping slicer is used to punch the separator and the negative electrode plate into a test sample strip with a size of length×width=20 cm×3 cm.

Step 2. The separator and the negative electrode plate are laminated through hot pressing, where the hot pressing is performed at a temperature of 80° C. under a pressure of 1 MPa for 60 s.

Step 3. A multi-grating photovoltaic solder strip peeling force tester is used to perform a 180° peel test on the separator and the negative electrode plate after the hot-pressing lamination, and the tested peeling force is the adhesive force of the first surface of the separator to the negative electrode plate.

If the interface between the negative electrode plate and the separator is an interface between the negative electrode plate and the first surface of the separator, the tested peeling force is an adhesive force F₂ of the first surface of the separator to the negative electrode plate. If the interface between the negative electrode plate and the separator is an interface between the negative electrode plate and a second surface of the separator, the tested peeling force is an adhesive force F₃ of the second surface of the separator to the negative electrode plate.

### Test for Room-Temperature Cycling Performance

Test temperature: 25° C.

Test process: The battery is charged to 4.2 V at a constant current of 4.5 C, charged to 4.3 V at a constant current of 3.5 C, charged to 4.4 V at a constant current of 3 C, charged to 0.02 C at a constant voltage of 4.4 V, left standing for 5 min, and discharged to 3.0 V at a constant current of 0.2 C. The cycle is performed 1500 times. A discharge capacity after the first cycle is recorded as C₀, and a discharge capacity after the 500th cycle is recorded as C₁.

$$Capacity retention rate ( \% ) = ( {C}_{1} / {C}_{0} ) \times 100 \% .$$

Capacity retention rate characterizes cycling performance. A higher capacity retention rate indicates better cycling performance.

### Test for Low-Temperature Cycling Performance

This is the same as the “Test for room-temperature cycling performance”, except that the test temperature is adjusted to 12° C.

### Example 1-1

### <Preparation of Separator>

PE with a thickness of 5 μm was used as a substrate, where a porosity of the substrate was 35%.

Filler particles boehmite and an inorganic coating binder polymethyl methacrylate (weight-average molecular weight: 170000) were mixed, added with deionized water as a solvent, and well stirred to form an inorganic coating slurry with a solid content of 40 wt %, where an average particle size of the filler particles Dᵥ50₋₁=1.0 μm.

Polymer particles polyvinylidene fluoride (PVDF) and an auxiliary binder carboxymethyl cellulose aqueous solution (solid content: 1 wt %, and weight-average molecular weight: 150000) were added to a mixer, added with deionized water as a solvent, and well stirred to form an adhesive layer slurry with a solid content of 4 wt %, where the average particle size of the polymer particles Dv50-2=0.8 μm.

The inorganic coating slurry was applied onto one surface of the substrate, followed by drying at 35° C. to form an inorganic coating on one surface of the substrate; and the adhesive layer slurry was applied to a surface of the inorganic coating facing away from the substrate and the other surface of the substrate through gravure coating, followed by drying at 35° C. to obtain a separator. For a structure of the separator, reference is made to FIG. 1 but is not limited to FIG. 1.

A coverage rate of the adhesive layer on the inorganic coating is 90%. A thickness T₁₂ of the inorganic coating is equal to 1.5 μm. Based on a mass of the inorganic coating, a mass percentage of the filler particles W₁=95%, and a mass percentage of the inorganic coating binder W₂=5%. Based on a mass of the adhesive layer, a mass percentage of the polymer particles W₃=97%, and a mass percentage of the auxiliary binder W₄=3%.

### <Preparation of Positive Electrode Plate>

A positive electrode active material LiCoO₂, a positive electrode conductive agent conductive carbon black (Super P), and a positive electrode binder polyvinylidene fluoride (PVDF, Dᵥ50: 500 nm) were mixed at a mass ratio of 97.5:1:1.5, added with N-methylpyrrolidone (NMP) as a solvent, and stirred in a vacuum mixer to obtain a positive electrode slurry with a solid content of 75 wt % and a homogeneous system. The positive electrode slurry was uniformly applied onto one surface of a positive electrode current collector aluminum foil with a thickness of 10 μm, followed by drying at 85° C. to obtain a positive electrode plate with one side coated with a positive electrode active material layer (with a thickness of 50 μm). Then, the foregoing steps were repeated on the other surface of the aluminum foil to obtain a positive electrode plate with both sides coated with the positive electrode active material layer. Cold pressing, slitting, and positive electrode tab welding are performed to obtain a positive electrode plate with a size of 74 mm×851 mm for later use.

### <Preparation of Negative Electrode Plate>

A negative electrode active material graphite, a negative electrode conductive agent conductive carbon black (Super P), a thickener carboxymethyl cellulose, and a binder styrene-butadiene rubber (SBR) were mixed at a mass ratio of 97.5:1:0.5:1, then added with deionized water as a solvent, and stirred in a vacuum mixer to obtain a negative electrode slurry with a solid content of 50 wt % and a homogeneous system. The negative electrode slurry was uniformly applied onto a surface of a negative electrode current collector copper foil with a thickness of 8 μm and dried at 85° C. to obtain a negative electrode plate with one side coated with a negative electrode active material layer (with a thickness of 60 μm). After that, the foregoing steps are repeated on the other surface of the copper foil to obtain a negative electrode plate with both sides coated with the negative electrode active material layer. Cold pressing, slitting, and positive electrode tab welding were performed to obtain and welded with tabs, to obtain the negative electrode plate with a size of 76 mm×867 mm for use.

### <Preparation of Electrolyte>

In a dry argon atmosphere, an organic solvent ethylene carbonate, ethyl methyl carbonate, and diethyl carbonate were mixed at a mass ratio of 30:50:20 to obtain an organic solution, a lithium salt lithium hexafluorophosphate was added and dissolved in the organic solvent, and then they were well mixed to obtain an electrolyte with a lithium salt concentration of 1.15 mol/L.

### <Preparation of Lithium-Ion Battery>

The above prepared separator (referred to as separator A), negative electrode plate, separator (referred to as separator B), and positive electrode plate were sequentially stacked and wound to obtain an electrode assembly of a wound structure, where a first surface of separator A was adjacent to the positive electrode plate and a first surface of separator B was adjacent to the positive electrode plate. The electrode assembly was placed into an aluminum-plastic film packaging bag and dried, and then the electrolyte was injected, followed by processes such as vacuum sealing, standing, formation, degassing, and trimming, to obtain a lithium-ion battery.

### Examples 1-2 to 1-25

These examples were the same as Example 1-1 except that the related preparation parameters were adjusted according to Table 1.

### Example 2-1

The <preparation of the separator> was the same as that of Example 1-6 except that the inorganic coatings were respectively provided on both surfaces of the substrate and the adhesive layers were respectively disposed on the surfaces of the two inorganic coatings facing away from the substrate. For a structure of the separator, reference is made to FIG. 2 but is not limited to FIG. 2.

The <preparation of lithium-ion battery> was the same as that of Example 1-6 except that the above prepared separator (referred to as separator A), negative electrode plate, separator (referred to as separator B), and positive electrode plate were sequentially stacked and wound to obtain an electrode assembly of a wound structure.

The <preparation of positive electrode plate>, <preparation of negative electrode plate>, and <preparation of electrolyte> were the same as those of Example 1-6.

### Examples 3-1 to 3-16

These examples were the same as Example 1-7 except that the related preparation parameters were adjusted according to Table 3.

### Example 4-1 to Example 4-9

These examples were the same as Example 1-7 except that the related preparation parameters were adjusted according to Table 4.

### Comparative Example 1 to Comparative Example 6

These examples were the same as Example 1-1 except that the related preparation parameters were adjusted according to Table 1.

The preparation parameters and performance parameters of the examples and comparative examples are shown in Table 1 to Table 4.

TABLE 1

| | | | | | | | | | | Room- | Low- |
|---|---|---|---|---|---|---|---|---|---|---|---|
| | | Coverage rate | | | | | | | | temperature | temperature |
| | | of adhesive | | | | Thickness | Impedance | | | cycling | cycling |
| | | layer on | | | | of | of | | | performance | performance |
| | | inorganic | | | | inorganic | adhesive | | | at 500th | at 500th |
| | A | coating | Dᵥ50₋₁ | Dᵥ50₋₂ | Dᵥ50₋₁/ | coating | layer | F₁ | F₃ | cycle | cycle |
| | (number) | (%) | (μm) | (μm) | Dᵥ50₋₂ | (μm) | (Ω) | (N/m) | (N/m) | (%) | (%) |
| Example | 100 | 90.0 | 1.00 | 0.80 | 1.30 | 1.50 | 0.50 | 40 | 30 | 50 | 45 |
| 1-1 | | | | | | | | | | | |
| Example | 90 | 82.2 | 1.00 | 0.80 | 1.30 | 1.50 | 0.40 | 36 | 25 | 55 | 50 |
| 1-2 | | | | | | | | | | | |
| Example | 80 | 74.5 | 1.00 | 0.80 | 1.30 | 1.50 | 0.30 | 34 | 23 | 57 | 52 |
| 1-3 | | | | | | | | | | | |
| Example | 70 | 66.7 | 1.00 | 0.80 | 1.30 | 1.50 | 0.23 | 32 | 21 | 60 | 54 |
| 1-4 | | | | | | | | | | | |
| Example | 60 | 58.9 | 1.00 | 0.80 | 1.30 | 1.50 | 0.20 | 30 | 20 | 63 | 56 |
| 1-5 | | | | | | | | | | | |
| Example | 50 | 51.1 | 1.00 | 0.80 | 1.30 | 1.50 | 0.16 | 25 | 23 | 65 | 60 |
| 1-6 | | | | | | | | | | | |
| Example | 40 | 43.3 | 1.00 | 0.80 | 1.30 | 1.50 | 0.13 | 20 | 13 | 75 | 70 |
| 1-7 | | | | | | | | | | | |
| Example | 30 | 35.6 | 1.00 | 0.80 | 1.30 | 1.50 | 0.10 | 15 | 12 | 78 | 76 |
| 1-8 | | | | | | | | | | | |
| Example | 20 | 27.8 | 1.00 | 0.80 | 1.30 | 1.50 | 0.08 | 13 | 10 | 80 | 78 |
| 1-9 | | | | | | | | | | | |
| Example | 10 | 20.0 | 1.00 | 0.80 | 1.30 | 1.50 | 0.05 | 10 | 10 | 73 | 70 |
| 1-10 | | | | | | | | | | | |
| Example | 50 | 55.0 | 1.00 | 0.40 | 2.50 | 1.50 | 0.12 | 12 | 11 | 68 | 65 |
| 1-11 | | | | | | | | | | | |
| Example | 50 | 53.0 | 1.00 | 0.50 | 2.00 | 1.50 | 0.10 | 13 | 10 | 70 | 69 |
| 1-12 | | | | | | | | | | | |
| Example | 50 | 53.0 | 0.80 | 0.50 | 1.60 | 1.50 | 0.12 | 18 | 13 | 72 | 70 |
| 1-13 | | | | | | | | | | | |
| Example | 50 | 51.1 | 0.80 | 0.80 | 1.00 | 1.50 | 0.13 | 20 | 18 | 74 | 72 |
| 1-14 | | | | | | | | | | | |
| Example | 50 | 51.1 | 0.60 | 0.80 | 0.70 | 1.50 | 0.14 | 24 | 19 | 73 | 70 |
| 1-15 | | | | | | | | | | | |
| Example | 50 | 51.1 | 0.30 | 0.80 | 0.40 | 1.50 | 0.22 | 25 | 20 | 65 | 62 |
| 1-16 | | | | | | | | | | | |
| Example | 50 | 47.0 | 0.20 | 1.00 | 0.20 | 1.50 | 0.25 | 27 | 24 | 64 | 60 |
| 1-17 | | | | | | | | | | | |
| Example | 50 | 56.0 | 0.50 | 0.60 | 0.80 | 1.50 | 0.23 | 28 | 26 | 68 | 63 |
| 1-18 | | | | | | | | | | | |
| Example | 50 | 66.0 | 0.20 | 0.20 | 1.00 | 1.50 | 0.25 | 20 | 18 | 60 | 56 |
| 1-19 | | | | | | | | | | | |
| Example | 50 | 45.0 | 1.00 | 1.20 | 0.80 | 1.50 | 0.20 | 25 | 20 | 58 | 56 |
| 1-20 | | | | | | | | | | | |
| Example | 40 | 43.3 | 1.00 | 0.80 | 1.30 | 2.00 | 0.14 | 20 | 13 | 74 | 69 |
| 1-21 | | | | | | | | | | | |
| Example | 40 | 48.0 | 0.50 | 0.60 | 0.80 | 1.00 | 0.15 | 22 | 15 | 75 | 70 |
| 1-22 | | | | | | | | | | | |
| Example | 40 | 53.0 | 0.20 | 0.40 | 0.50 | 0.50 | 0.23 | 24 | 22 | 68 | 60 |
| 1-23 | | | | | | | | | | | |
| Example | 40 | 53.0 | 0.20 | 0.40 | 0.50 | 0.20 | 0.20 | 24 | 22 | 66 | 60 |
| 1-24 | | | | | | | | | | | |
| Example | 40 | 43.3 | 1.00 | 0.80 | 1.30 | 2.30 | 0.28 | 21 | 14 | 65 | 59 |
| 1-25 | | | | | | | | | | | |
| Comparative | 120 | 96.0 | 1.00 | 0.60 | 1.70 | 1.50 | 1.00 | 70 | 65 | 45 | 35 |
| example 1 | | | | | | | | | | | |
| Comparative | 110 | 94.0 | 1.00 | 0.60 | 1.70 | 1.50 | 0.90 | 60 | 56 | 48 | 40 |
| example 2 | | | | | | | | | | | |
| Comparative | 5 | 15.0 | 1.00 | 0.60 | 1.70 | 1.50 | 0.01 | 8 | 4 | 65 | 60 |
| example 3 | | | | | | | | | | | |
| Comparative | 40 | 47 | 1.80 | 0.60 | 3.00 | 1.50 | 0.08 | 3 | 2 | 70 | 65 |
| example 4 | | | | | | | | | | | |
| Comparative | 40 | 47 | 2.40 | 0.60 | 4.00 | 1.50 | 0.06 | 2 | 1 | 67 | 60 |
| example 5 | | | | | | | | | | | |
| Comparative | 40 | 47 | 0.15 | 0.80 | 0.19 | 1.50 | 0.30 | 17 | 15 | 44 | 40 |
| example 6 | | | | | | | | | | | |

From Examples 1-1 to 1-20 and Comparative Examples 1 to 6, it can be seen that in the lithium-ion battery in each example of this application, the quantity A of the polymer particles in the first surface of the separator, the average particle size Dᵥ50₋₁ of the filler particles in the inorganic coating, and the ratio Dᵥ50₋₁/Dᵥ50₋₂ of the average particle size of the filler particles in the inorganic coating and the average particle size of the polymer particles in the adhesive layer are adjusted to be within the ranges provided in this application, so that the adhesive layer has an appropriate impedance, the first surface of the separator has a high adhesive force to the surfaces of the positive electrode plate and negative electrode plate, and the lithium-ion battery has good room-temperature cycling performance and low-temperature cycling performance, indicating that the lithium-ion battery has improved room-temperature cycling performance and low-temperature cycling performance while having good safety performance. In contrast, in the lithium-ion battery in each comparative example, at least one of the quantity A of the polymer particles in the first surface of the separator, the average particle size Dᵥ50₋₁ of the filler particles in the inorganic coating, or the ratio Dᵥ50₋₁/Dᵥ50₋₂ of the average particle size of the filler particles in the inorganic coating and the average particle size of the polymer particles in the adhesive layer is not within the ranges provided in this application, resulting in excessively large or excessively small impedance of the adhesive layer, excessively large or excessively small adhesive force between the first surface of the separator and the positive electrode plate and negative electrode plate. Consequently, the lithium-ion battery has degraded room-temperature cycling performance and low-temperature cycling performance while having good safety performance, or the lithium-ion battery fails to ensure the safety performance while having good room-temperature cycling performance and low-temperature cycling performance.

The quantity A of the polymer particles in the first surface of the separator usually affects the room-temperature cycling performance, low-temperature cycling performance, and safety performance of lithium-ion batteries. From Examples 1-1 to 1-10, and Comparative examples 1 to 3, it can be seen that a lithium-ion battery in which the quantity A of the polymer particles in the first surface of the separator is within the ranges provided in this application is selected, the first surface of the separator has a large adhesive force to the surfaces of the positive electrode plate and negative electrode plate, and the lithium-ion battery has good room-temperature cycling performance and low-temperature cycling performance, indicating that the lithium-ion battery has good room-temperature cycling performance and low-temperature cycling performance while having good safety performance.

The average particle size Dᵥ50₋₁ of the filler particles, the average particle size Dᵥ50₋₂ of the polymer particles, and the ratio Dᵥ50₋₁/Dᵥ50₋₂ of the average particle size of the filler particles and the average particle size of the polymer particles usually affect the room-temperature cycling performance, the low-temperature cycling performance, and the safety performance of the lithium-ion battery. From Examples 1-6 and 1-11 to 1-20, and Comparative examples 4 to 6, it can be seen that a lithium-ion battery in which the average particle size Dᵥ50₋₁ of the filler particles, the average particle size Dᵥ50₋₂ of the polymer particles, and the ratio Dᵥ50₋₁/Dᵥ50₋₂ of the average particle size of the filler particles and the average particle size of the polymer particles are within the ranges provided in this application is selected, so that the first surface of the separator has a large adhesive force to the surfaces of the positive electrode plate and negative electrode plate, and the lithium-ion battery has good room-temperature cycling performance and low-temperature cycling performance, indicating that the lithium-ion battery has good room-temperature cycling performance and low-temperature cycling performance while having good safety performance.

The thickness of the inorganic coating usually affects the room-temperature cycling performance and low-temperature cycling performance of lithium-ion batteries. From Examples 1-7 and 1-21 to 1-25, it can be seen that a lithium-ion battery in which the thickness of the inorganic coating is within the ranges provided in this application is selected, and the lithium-ion battery has good room-temperature cycling performance and low-temperature cycling performance.

TABLE 2

| | | | | | | Room- | Low- |
|---|---|---|---|---|---|---|---|
| | | Impedance | | | | temperature | temperature |
| | | of | | | | cycling | cycling |
| | | adhesive | | | | performance at | performance at |
| | | layer | F₁ | F₂ | F₃ | 500th cycle | 500th cycle |
| | Separator structure | (Ω) | (N/m) | (N/m) | (N/m) | (%) | (%) |
| Example | An inorganic coating | 0.16 | 25 | — | 23 | 65 | 60 |
| 1-6 | and an adhesive layer | | | | | | |
| | were sequentially | | | | | | |
| | disposed on one surface | | | | | | |
| | of the substrate, and an | | | | | | |
| | adhesive layer was | | | | | | |
| | disposed on the other | | | | | | |
| | surface of the substrate. | | | | | | |
| Example | An inorganic coating | 0.12 | 25 | 20 | — | 68 | 64 |
| 2-1 | and an adhesive layer | | | | | | |
| | were sequentially | | | | | | |
| | disposed on both | | | | | | |
| | surfaces of the | | | | | | |
| | substrate. | | | | | | |

Note:
In Table 2, “—” indicates that there are no corresponding parameters. Specifically, a value of F₂ corresponding to Example 1-6 is “—” because the surface of one side of the separator in Example 1-6 is the first surface, while the other side is the second surface, and the second surface of the separator is adjacent to the negative electrode plate. Therefore, the interface between the negative electrode plate and the separator is the interface between the negative electrode plate and the second surface of the separator, and the adhesive force obtained in the adhesive force test is the adhesive force F₃ of the second surface of the separator to the negative electrode plate. A value of F₃ corresponding to Example 2-1 is “—” because the surfaces of two sides of the separator in Example 2-1 are both the first surfaces. Therefore, the interface between the negative electrode plate and the separator is the interface between the negative electrode plate and the first surface of the separator, and the adhesive force obtained in the adhesive force test is the adhesive force F₂ of the first surface of the separator to the negative electrode plate.

The structure of the separator also usually affects the room-temperature cycling performance and low-temperature cycling performance of lithium-ion batteries. From Examples 1-6 and 2-1, it can be seen that a lithium-ion battery in which the structure of the separator is within the ranges provided in this application is selected, so that the separator has a large adhesive force to the positive electrode plate and negative electrode plate, and the lithium-ion battery has good room-temperature cycling performance and low-temperature cycling performance. The adhesive force F₃ of the second surface of the separator to the negative electrode plate in Example 1-6 is superior to the adhesive force F₂ of the first surface of the separator to the negative electrode plate in Example 2-1 because in Example 1-6, only one side of the separator is provided with the adhesive layer, and the adhesive layer is directly disposed on the substrate, resulting in a larger adhesive force of the adhesive layer. However, when both sides of the separator are provided with the inorganic coating, a higher electrolyte retention rate is achieved, so that the room-temperature cycling performance and low-temperature cycling performance of the lithium-ion battery are further improved.

TABLE 3

| | | | | | Room- | Low- |
|---|---|---|---|---|---|---|
| | | | | | temperature | temperature |
| | | | Type of | | cycling | cycling |
| | Type of | | inorganic | | performance at | performance at |
| | filler | W₁ | coating | W₂ | 500th cycle | 500th cycle |
| | particles | (%) | binder | (%) | (%) | (%) |
| Example | Boehmite | 95 | Polymethyl | 5 | 75 | 70 |
| 1-7 | | | acrylate | | | |
| Example | Aluminum | 95 | Polymethyl | 5 | 75 | 72 |
| 3-1 | oxide | | acrylate | | | |
| Example | Zirconium | 95 | Polymethyl | 5 | 74 | 71 |
| 3-2 | oxide | | acrylate | | | |
| Example | Mullite | 95 | Polymethyl | 5 | 70 | 68 |
| 3-3 | | | acrylate | | | |
| Example | Silicon | 95 | Polymethyl | 5 | 69 | 67 |
| 3-4 | nitride | | acrylate | | | |
| Example | Silicon | 95 | Polymethyl | 5 | 69 | 67 |
| 3-5 | carbide | | acrylate | | | |
| Example | Magnesium | 95 | Polymethyl | 5 | 72 | 71 |
| 3-6 | oxide | | acrylate | | | |
| Example | Titanium | 95 | Polymethyl | 5 | 66 | 63 |
| 3-7 | dioxide | | acrylate | | | |
| Example | Boehmite | 95 | PVA | 5 | 59 | 50 |
| 3-8 | | | (Mw = 130000) | | | |
| Example | Boehmite | 95 | PAA | 5 | 65 | 60 |
| 3-9 | | | (Mw = 140000) | | | |
| Example | Boehmite | 95 | Hydroxymethyl | 5 | 64 | 62 |
| 3-10 | | | cellulose | | | |
| | | | (Mw = 2500000) | | | |
| Example | Boehmite | 95 | SBR | 5 | 70 | 69 |
| 3-11 | | | (Mw = 180000) | | | |
| Example | Boehmite | 95 | Polymethyl | 5 | 73 | 70 |
| 3-12 | | | acrylate | | | |
| Example | Boehmite | 97 | Polymethyl | 3 | 76 | 72 |
| 3-13 | | | acrylate | | | |
| Example | Boehmite | 99 | Polymethyl | 1 | 63 | 59 |
| 3-14 | | | acrylate | | | |
| Example | Boehmite | 99.5 | Polymethyl | 0.5 | 56 | 55 |
| 3-15 | | | acrylate | | | |
| Example | Boehmite | 94 | Polymethyl | 6 | 53 | 51 |
| 3-16 | | | acrylate | | | |

The types of the filler particles and inorganic coating binders usually affect the room-temperature cycling performance and low-temperature cycling performance of lithium-ion batteries. From Examples 1-7 and 3-1 to 3-11, it can be seen that a lithium-ion battery in which the types of the filler particles and inorganic coating binders are within the ranges provided in this application is selected, so that the separator has a large adhesive force to the positive electrode plate and negative electrode plate, and the lithium-ion battery has good room-temperature cycling performance and low-temperature cycling performance.

The mass percentages of the filler particles and inorganic coating binders in the inorganic coating usually affect the room-temperature cycling performance and low-temperature cycling performance of lithium-ion batteries. From Examples 1-7 and 3-12 to 3-16, it can be seen that a lithium-ion battery in which the mass percentages of the filler particles and inorganic coating binders in the inorganic coating are within the ranged provided in this application is selected, so that the separator of the lithium-ion battery has a large adhesive force to the positive electrode plate and negative electrode plate, and the lithium-ion battery has good room-temperature cycling performance and low-temperature cycling performance.

TABLE 4

| | | | | | | | | Room- | Low- |
|---|---|---|---|---|---|---|---|---|---|
| | | | | | Impedance | | | temperature | temperature |
| | | | | | of | | | cycling | cycling |
| | Type of | | Type of | | adhesive | | | performance at | performance at |
| | polymer | W₃ | auxiliary | W₄ | layer | F₁ | F₂ | 500th cycle | 500th cycle |
| | particles | (%) | binder | (%) | (Ω) | (N/m) | (N/m) | (%) | (%) |
| Example 1-7 | PVDF | 97 | Carboxymethyl | 3 | 0.13 | 20 | 13 | 75 | 70 |
| | | | cellulose | | | | | | |
| Example 4-1 | Polymethyl | 97 | Carboxymethyl | 3 | 0.12 | 22 | 14 | 74 | 72 |
| | methacrylate | | cellulose | | | | | | |
| | (Mw = 160000) | | | | | | | | |
| Example 4-2 | Polymethyl | 97 | Carboxymethyl | 3 | 0.11 | 24 | 16 | 75 | 73 |
| | acrylate | | cellulose | | | | | | |
| | (Mw = 250000) | | | | | | | | |
| Example 4-3 | PVDF | 97 | PVA | 3 | 0.15 | 22 | 15 | 71 | 68 |
| | | | (Mw = 170000) | | | | | | |
| Example 4-4 | PVDF | 97 | PAA | 3 | 0.14 | 24 | 16 | 73 | 70 |
| | | | (Mw = 200000) | | | | | | |
| Example 4-5 | PVDF | 97 | Carboxymethyl | 3 | 0.13 | 20 | 13 | 73 | 70 |
| | | | cellulose | | | | | | |
| Example 4-6 | PVDF | 98 | Carboxymethyl | 2 | 0.12 | 19 | 12 | 75 | 73 |
| | | | cellulose | | | | | | |
| Example 4-7 | PVDF | 99.5 | Carboxymethyl | 0.5 | 0.10 | 18 | 11 | 79 | 76 |
| | | | cellulose | | | | | | |
| Example 4-8 | PVDF | 96 | Carboxymethyl | 4 | 0.22 | 22 | 15 | 65 | 60 |
| | | | cellulose | | | | | | |
| Example 4-9 | PVDF | 99.8 | Carboxymethyl | 0.2 | 0.08 | 15 | 11 | 67 | 66 |
| | | | cellulose | | | | | | |

The types of polymer particles and auxiliary binders usually affect the room-temperature cycling performance and low-temperature cycling performance of lithium-ion batteries. From Examples 1-7 and 4-1 to 4-4, it can be seen that a lithium-ion battery in which the types of the polymer particles and auxiliary binders are within the ranges provided in this application is selected, and the lithium-ion battery has good room-temperature cycling performance and low-temperature cycling performance.

The mass percentages of the polymer particles and auxiliary binders in the adhesive layer usually affect the room-temperature cycling performance and low-temperature cycling performance of lithium-ion batteries. From Examples 1-7 and 4-5 to 4-9, it can be seen that a lithium-ion battery in which the mass percentages of the polymer particles and auxiliary binders in the adhesive layer are within the ranges provided in this application is selected, and the lithium-ion battery has good room-temperature cycling performance and low-temperature cycling performance.

It should be noted that relational terms such as “first” and “second” herein are only used to distinguish one entity or operation from another entity or operation, and do not necessarily require or imply that there is any such actual relationship or order between these entities or operations. In addition, the terms “comprise”, “include”, or any other variations thereof are intended to cover non-exclusive inclusions, such that a process, method, article or device including a series of elements not only includes these elements, but also includes other elements which are not expressly listed, or further includes elements which are inherent to such process, method, article or device.

All embodiments in this specification are described in a related manner. For a part that is the same or similar between some embodiments, reference may be made between some embodiments. Each embodiment focuses on differences from other embodiments.

The foregoing descriptions are merely preferred embodiments of this application, and are not intended to limit this application. Any modifications, equivalent replacements, improvements, and the like made without departing from the spirit and principle of this application shall fall within the protection scope of this application.

What is claimed is:

1. A separator, comprising a substrate, an inorganic coating layer, and an adhesive layer; wherein the inorganic coating layer and the adhesive layer are disposed on a first surface of the substrate; the inorganic coating layer is disposed between the substrate and the adhesive layer on the first surface; the adhesive layer is further disposed on a second surface of the substrate; the inorganic coating layer comprises filler particles;
and the adhesive layer comprises polymer particles;
in a region with an area of 100 μm² on the first surface, a quantity of the polymer particles is A, wherein 10≤A≤100; and
an average particle size of the filler particles is Dᵥ50₋₁ μm, and an average particle size of the polymer particles is Dᵥ50₋₂ μm, wherein 0.2≤Dᵥ50₋₁/Dᵥ50₋₂≤2.5 and 0.2≤Dᵥ50₋₁≤1.

2. The separator according to claim 1, wherein 0.4≤Dᵥ50₋₂≤1.

3. The separator according to claim 1, wherein a thickness of the inorganic coating layer is 0.2 μm to 2 μm.

4. The separator according to claim 1, wherein a coverage rate of the adhesive layer on the inorganic coating layer is 20% to 90%.

5. The separator according to claim 2, wherein the separator satisfies at least one of the following (1) to (6):
$$( 1 ) 10 \leq A \leq 60 ;$$
$$( 2 ) 0.7 \leq {D}_{v} 5 {0}_{- 1} / Dv {50}_{- 2} \leq 1.6 ;$$
$$( 3 ) 0.5 \leq {D}_{v} 5 {0}_{- 1} \leq 0.8 ;$$
$$( 4 ) 0.5 \leq {D}_{v} 5 {0}_{- 2} \leq 0.8 ;$$
(5) a thickness of the inorganic coating layer is 0.5 μm to 1.5 μm; or
(6) a coverage rate of the adhesive layer on the inorganic coating layer is 20% to 60%.

6. The separator according to claim 1, wherein the inorganic coating layer further comprises an inorganic coating layer binder; the filler particles comprise at least one of boehmite, aluminum oxide, zirconium oxide, titanium dioxide, magnesium oxide, mullite, silicon carbide, or silicon nitride; the inorganic coating layer binder comprises at least one of polyvinyl alcohol, polyacrylic acid, hydroxypropyl cellulose, styrene-butadiene rubber, or polymethyl methacrylate; and
based on a mass of the inorganic coating layer, a mass percentage of the filler particles is 95% to 99%, and a mass percentage of the inorganic coating layer binder is 1% to 5%.

7. The separator according to claim 1, wherein the adhesive layer further comprises an auxiliary binder; the polymer particles comprise at least one of polyvinylidene fluoride, polymethyl methacrylate, polymethyl acrylate, or polyethyl acrylate; the auxiliary binder comprises at least one of polyvinyl alcohol, polyacrylic acid, hydroxypropyl cellulose, or styrene-butadiene rubber; and
based on a mass of the adhesive layer, a mass percentage of the polymer particles is 97% to 99.5%, and a mass percentage of the auxiliary binder is 0.5% to 3%.

8. The separator according to claim 1, wherein the second surface of the substrate is further provided with the inorganic coating layer, and the inorganic coating layer is disposed between the substrate and the adhesive layer on the second surface.

9. The separator according to claim 8, wherein an impedance of the adhesive layer is 0.05Ω to 0.5 Ω.

10. The separator according to claim 8, wherein an impedance of the adhesive layer is 0.05Ω to 0.2 Ω.

11. An electrochemical apparatus, wherein the electrochemical apparatus comprises a separator; the separator comprises a substrate, an inorganic coating layer, and an adhesive layer; wherein the inorganic coating layer and the adhesive layer are disposed on a first surface of the substrate; the inorganic coating layer is disposed between the substrate and the adhesive layer; the adhesive layer is disposed on a second surface of the substrate; the inorganic coating layer comprises filler particles; and the adhesive layer comprises polymer particles;
in a region with an area of 100 μm² on the first surface, a quantity of the polymer particles is A, wherein 10≤A≤100; and
an average particle size of the filler particles is Dv50-1 μm, and an average particle size of the polymer particles is Dv50-2 μm, wherein Dv50-1 and Dv50-2 satisfy: 0.2≤Dv50-1/Dv50-2≤2.5 and 0.2≤Dv50-1≤1.

12. The electrochemical apparatus according to claim 11, wherein 0.4≤Dᵥ50₋₂≤1.

13. The electrochemical apparatus according to claim 11, wherein a thickness of the inorganic coating layer is 0.2 μm to 2 μm.

14. The electrochemical apparatus according to claim 11, wherein a coverage rate of the adhesive layer on the inorganic coating layer is 20% to 90%.

15. The electrochemical apparatus according to claim 12, wherein the separator satisfies at least one of the following (1) to (6):
$$( 1 ) 10 ⩽ A ⩽ 60 ;$$
$$( 2 ) 0.7 ⩽ Dv 50 - 1 / Dv 50 - 2 ⩽ 1.6 ;$$
$$( 3 ) 0.5 ⩽ Dv 50 - 1 ⩽ 0.8 ;$$
$$( 4 ) 0.5 ⩽ Dv 50 - 2 ⩽ 0.8 ;$$
(5) a thickness of the inorganic coating layer is 0.5 μm to 1.5 μm; or
(6) a coverage rate of the adhesive layer on the inorganic coating layer is 20% to 60%.

16. The electrochemical apparatus according to claim 11, wherein the inorganic coating layer further comprises an inorganic coating layer binder; the filler particles comprise at least one of boehmite, aluminum oxide, zirconium oxide, titanium dioxide, magnesium oxide, mullite, silicon carbide, or silicon nitride; the inorganic coating layer binder comprises at least one of polyvinyl alcohol, polyacrylic acid, hydroxypropyl cellulose, styrene-butadiene rubber, or polymethyl methacrylate; and
based on a mass of the inorganic coating layer, a mass percentage of the filler particles is 95% to 99%, and a mass percentage of the inorganic coating layer binder is 1% to 5%.

17. The electrochemical apparatus according to claim 11, wherein the adhesive layer further comprises an auxiliary binder, the polymer particles comprise at least one of polyvinylidene fluoride, polymethyl methacrylate, polymethyl acrylate, or polyethyl acrylate; the auxiliary binder comprises at least one of polyvinyl alcohol, polyacrylic acid, hydroxypropyl cellulose, or styrene-butadiene rubber; and
based on a mass of the adhesive layer, a mass percentage of the polymer particles is 97% to 99.5%, and a mass percentage of the auxiliary binder is 0.5% to 3%.

18. The electrochemical apparatus according to claim 11, wherein an adhesive force F1 of the first surface to a positive electrode plate is 10 N/m to 40 N/m, and an adhesive force F2 of the first surface to a negative electrode plate is 10 N/m to 30 N/m.

19. The electrochemical apparatus according to claim 11, wherein the adhesive force F1 of the first surface to the positive electrode plate is 10 N/m to 30 N/m, and the adhesive force F2 of the first surface to the negative electrode plate is 10 N/m to 20 N/m.

20. An electronic apparatus, wherein the electronic apparatus comprises the electrochemical apparatus according to claim 11.
